(19) United States
(12) Patent Application Publication
(10) Pub. No.: US 2010/0038458 A1
(43) Pub. Date: Feb. 18, 2010

(54) Fuel injector having an energy attenuator sub-assembly for the valve seat

(76) Inventor: Raul A. Bircann, Penfield, NY (US)

Correspondence Address: Delphi Technologies, Inc., M/C 480-410-202, PO BOX 5052, Troy, MI, 48007, US

(21) Appl. No.: 12/228,351

(22) Filed: Aug. 12, 2008

(51) Int. Cl. B05B 1/30

(52) U.S. Cl. 239/584

(57) ABSTRACT

A fuel injector for dispensing gaseous fuel into an internal combustion engine, including a valve body having an axial bore; a valve seat sub-assembly slidably disposed in the axial bore; a valve needle sub-assembly disposed within the axial bore and selectively matable with the valve seat sub-assembly; an electrical actuator connected to the valve needle sub-assembly for moving the valve needle sub-assembly in alternating axial directions to cause the valve needle to make intermittent contact with and separate from the valve seat sub-assembly to control flow of fuel from the outlet end; and an energy attenuator sub-assembly having a polymeric resilient layer fixedly disposed in the axial bore and in contact with the valve seat sub-assembly to bias the valve seat sub-assembly against the valve needle sub-assembly to dampen closing impact of the valve needle sub-assembly against the valve seat sub-assembly.

### TECHNICAL FIELD

The present invention relates to fuel injectors; more particularly, to fuel injectors suitable for injecting gaseous fuels into the combustion chambers of internal combustion engines; and most particularly, to a gas fuel injector having an energy-absorbing valve seat assembly.

### BACKGROUND OF THE INVENTION

In high speed fluid metering solenoids, armature bounce is a problem because each bounce of the armature and attached valving element meters a small, uncontrolled amount of fuel into the engine, to the detriment of emissions. As can be appreciated, such leakage of fuel into the engine will result in very unfavorable fuel economy. At either end of its motion, the armature has kinetic energy as a result of its mass and velocity. With no means for dissipation, that energy is returned to the armature by elastic collision with the stop. Eventually, the energy is dissipated after a series of collisions and bounces. The bounce of the armature affects the operation of a fuel injector by prolonging or shortening the duration of injection and also causes excessive wear in the valve seat area.

The ever-increasing cost of fuel for automotive applications has prompted consideration of compressed natural gas (CNG) as a viable fuel. Currently, CNG offers several advantages over common liquid fuels in terms of cost/BTU and carbon dioxide (CO₂) emissions. Operating savings of greater than 50 percent are possible, particularly at retail gasoline prices exceeding $3.00/gallon. CO₂ reductions of more than 25 percent are attainable with CNG in comparison with gasoline and other liquid fuels.

By 2010, the volume of CNG-fueled vehicles worldwide is expected to increase ten-fold relative to 2004, with highest usage in Europe, China, and South America. Total volume may exceed 2.4 million units.

Natural gas, being a light and gaseous fuel, poses some unique challenges in automotive applications, particularly as concerning durability and noise. The medium does not provide the beneficial damping and lubricating properties associated with liquid fuels such as gasoline and diesel. Consequently, impact kinetic energy goes largely unattenuated, as compared to metering of liquids, which can result in generation of high and concentrated impact stresses.

Such stresses are particularly detrimental to durability of fuel injectors and intake valves. Some manufacturers using fuel injectors intended originally for liquid fuel use have experienced problems with significantly shortened durability and excessive noise. Resolution of these issues is important for the viability of natural gas as an engine fuel source that might one day entirely replace liquid fuels.

U.S. Pat. No. 5,236,173 discloses a fuel injector having a resilient mechanical valve seat comprising a metal spring such as a Belleville washer or a wave washer for absorbing the impact of a valve head or needle when the valve closes. A shortcoming of such an impact-absorbing seat is that, over time of use, the edges of the metal spring can wear into the seat and/or the seat support, thus changing the effective stroke of the valve and changing the amount of fuel delivered with each stroke.

Some manufacturers have attempted to address the inherent impact stresses and noise issues by using soft elastomeric interfaces in the fuel injector valve seat. However, these approaches have mostly been unsuccessful, as elastomers have shown a susceptibility to low-temperature stiction and to long-term deterioration from repeated impact cycling. Additionally, a soft seating interface has necessitated unique valve driving schemes requiring greater current levels than most vehicle engine controllers can accommodate. For example, low-temperature stiction between the valve needle and the valve seat, which results from residual compressor oil and other contaminants, has impaired operation at temperatures below 10° C. This temperature limitation precludes widespread usage of prior art elastomeric valve seats in many countries outside the tropics.

What is needed in the art is an improved means for damping the motion of an armature to diminish bounce, thereby diminishing the uncontrolled amount of fuel dispensed into the engine and wear in the valve seat area.

What is further needed in the art is a fuel injector valve seat arrangement with energy-attenuating properties, capable of long-term wear resistance while being unsusceptible to low-temperature stiction with the valve needle.

It is a principal object of the present invention to improve the operating and wear characteristics of a fuel injector when used to meter gaseous fuel to an internal combustion engine.

### SUMMARY OF THE INVENTION

Briefly described, a valve seat for a solenoid-actuated poppet valve such as a fuel injector is provided with an energy attenuator subassembly disposed between the valve seat and the body of the fuel injector. Energy dissipation is achieved by using a ring of resilient material, preferably an elastomer bonded or otherwise retained to a backing or-carrier plate to hold the valve seat against the valve needle, preventing fuel seepage to the engine when the valve is in a closed condition. Such energy dissipation prevents a significant amount of needle and armature bounce, thus increasing both accuracy and precision of fuel injection.

### BRIEF DESCRIPTION OF THE DRAWINGS

The present invention will now be described, by way of example, with reference to the accompanying drawings, in which:

FIG. 1 is an elevational cross-sectional view of a prior art fuel injector having a conventional valve seat arrangement without a resilient energy attenuator;

FIG. 2 is an elevational cross-sectional view of an energy attenuator subassembly in accordance with the present invention;

FIG. 3 is an elevational cross-sectional view of a fuel injector in accordance with the present invention including the energy attenuator subassembly shown in FIG. 2;

FIG. 4 is a graph showing bounce of a valve needle against a valve seat in a prior art fuel injector; and

FIG. 5 is a graph showing bounce of a valve needle against a valve seat in a fuel injector improved in accordance with the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

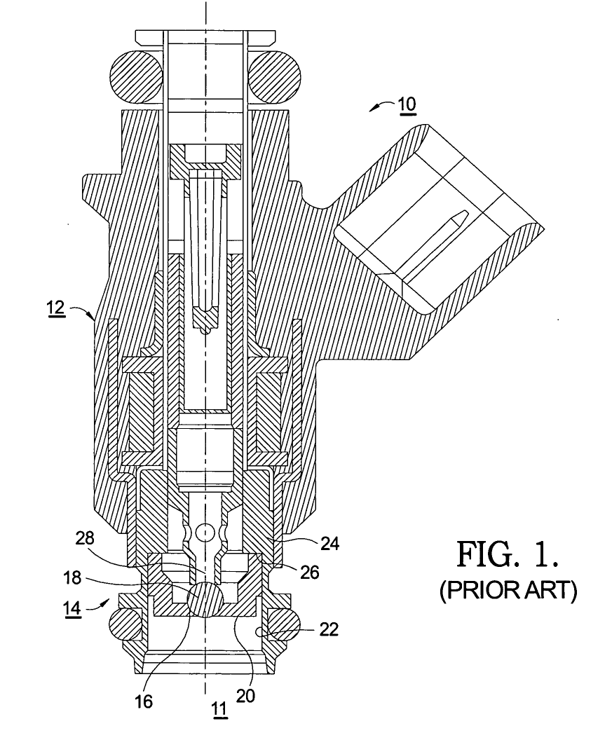

Referring to FIG. 1, a prior art liquid fuel injector 10 is shown, for injecting fuel into a cylinder of an internal combustion engine 11. Fuel injector 10 comprises two principal sub-assemblies: an actuator sub-assembly 12 and a metering sub-assembly 14. As a conventional actuator sub-assembly is well known in the prior art, and as the present invention is concerned only with the metering sub-assembly, description will be limited to metering sub-assembly 14 which cross-sectionally illustrates the source of the problem solved by the present invention as described below.

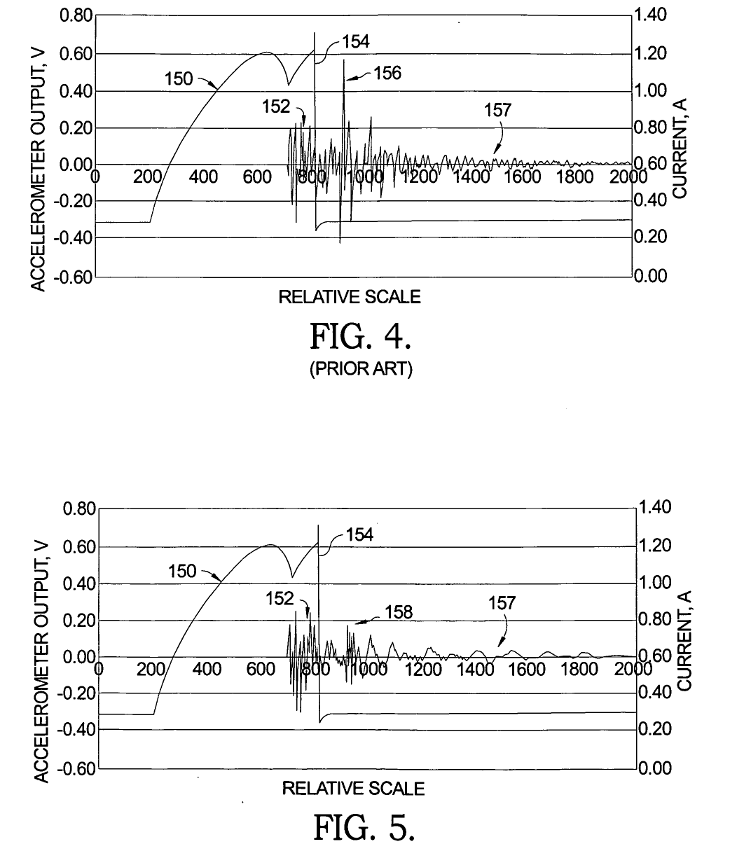

As can be readily seen, during valve actuation the interval of intimacy 16 between steel metering valve 18 and steel seat sub-assembly 20 is very small and narrow which inherently results in large imparted stress values upon collision therebetween, which stress is increased by the relatively great stiffness of the steel components involved in the impact. Consequently, the collision is highly elastic, resulting in a decaying series of bounces of valve needle assembly 28 (which comprises valve 18) against seat sub-assembly 20 (see discussion of FIG. 4 below). Repetitive impact cycling can result in interfacial distortion and deterioration, and/or ultimate breakage, as a form of energy dissipation. Various known fuel injectors are of this nature and are deficient in terms of performance and durability, with some lasting fewer than 50,000 km of vehicle usage, out of an expected 200,000 km vehicle lifetime.

In prior art fuel injector 10, seat sub-assembly 20 forms a snug fit within bore 22 in body 24 and is secured in place as by laser welding. During assembly of fuel injector 10, seat sub-assembly 20 is stopped against first positioning shoulder 26 which correctly positions the seat sub-assembly axially of the fuel injector. The valve seat thus becomes the axial reference against which the stroke of valve needle assembly 28 is adjusted and calibrated.

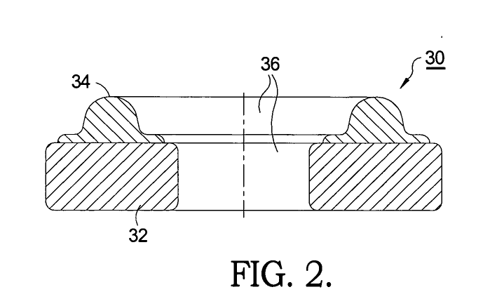

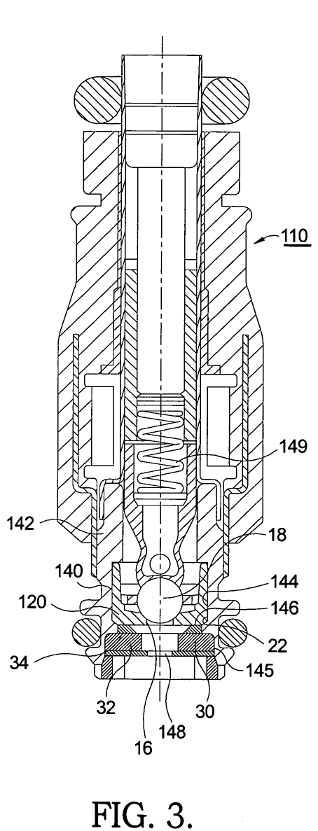

Referring to FIG. 2, an energy attenuator sub-assembly 30 in accordance with the present invention comprises an energy attenuator backing plate 32 and an energy attenuator compliant element 34 preferably bonded to backing plate 32, both of which preferably are ring-shaped and have a central opening 36 for passage of injected fuel as will be seen in FIG. 3. Preferably, compliant element 34 is formed of an elastomer having a broad temperature range of relative elasticity and resilient compressibility, e.g., from about −40° C. to about 160° C., and neglibile swelling in the presence of hyrdocarbon fuels. Elastomers such as fluorocarbon polymers work especially well, whereas elastomers such as natural rubber and polynitriles are not especially desirable as they can undergo appreciable low temperature stiffening and, therefore, suffer from increased impact force and reduced life expectancy. Fluorosilicone polymer is also not recommended due to its inherently low tear resistance.

Referring to FIG. 3, an improved fuel injector 110 is shown having integral energy attenuating capability. The principal differences between improved fuel injector 110 and prior art fuel injector 10 are energy attenuator subassembly 30 and an engineered tight slip interface 140 between metering sub-assembly housing 142, and outer diameter 144 of seat sub-assembly 120.

Energy attenuator sub-assembly 30, as described above, comprises a compliant element 34, which preferably is elastomeric, bonded or otherwise retained to a backing plate 32. Energy attenuator sub-assembly 30 is sealingly welded into said axial bore 22 preferably against a second positioning shoulder 145 in a state of pre-compression commensurate with impact loading requirements, whereby loads are withstood and dissipated by virtue of engineered inherent stiffness and damping properties of compliant element 34. Because of the tight slip fit between seat sub-assembly 120 and metering sub-assembly housing 142 at their immediate interface 140, permitting very slight reciprocal axial motion of seat sub-assembly 120 within bore 22, the impact force of metering ball 18 against seat sub-assembly interface 146 is transmitted virtually unhindered to energy attenuator sub-assembly 30 wherein it is fully absorbed and dissipated by compliant element 34, thereby eliminating or minimizing impact stress-induced damage and noise. Energy attenuator sub-assembly 30 also serves the additional function of providing a face seal of seat sub-assembly 120 at bottom interface 146, preventing leakage of fuel along interface 140. This seal is completed via perimeter or similar weldment of backing plate 32 to metering sub-assembly housing 142; thus, the only open path for fuel flow is past metering valve 18 and seat sub-assembly interface 16 and on through discharge orifice 148.

It will be appreciated, of course, that backing plate 32 may comprise an element formed separate from and pressed into the valve body, as shown in FIG. 3, or alternatively and within the scope of the present invention may comprise an element formed integrally with the valve body.

Referring now to FIGS. 4 and 5, the benefit of providing energy attenuator sub-assembly 30 within improved fuel injector 110 is shown analytically using an accelerometer. These figures show solenoid current 150 during solenoid actuation events of prior art fuel injector 10 (FIG. 4) and improved fuel injector 110 (FIG. 5), respectively, and the resulting accelerometer depiction of the motion of valve needle assembly 28 and valve 18. The stroke of the solenoid armature was 180 μm, the fuel pressure drop across the valve was 8 bar, and the injected gaseous fuel was CNG.

It is seen in both fuel injectors that as amperage 150 approaches a maximum, causing the valve to be wide open, the position of the valve needle and valve is somewhat noisy 152. At current cutoff 154, the valve needle and ball are rapidly returned to high-impact contact with their respective seat sub-assemblies 20,120 by release of return spring 149 (FIG. 3, and omitted from FIG. 1), resulting in a diminishing series of bounces 157 of the ball against the seat. In prior art fuel injector 10, the motion of the ball is very noisy and creates a maximum accelerometer value 156 of nearly 0.60 volts; whereas in improved fuel injector 110, the motion of the ball is much less noisy and creates a maximum accelerometer value 158 of less than 0.20 volts.

It will be appreciated that the present invention reduces armature bounce by adding energy dissipation and a lower rate for the elastic part of the collision with the stop, which effectively reduces the amount of fuel uncontrollably injected into the engine. When the valve needle and ball are held against the valve seat by the preload force of a damping member, the kinetic energy of the armature collision is turned into spring potential energy by moving the assembly mass, including armature mass, back against the damping member. The damping member preload is large enough to maintain accurate seat assembly geometry even with the pressure force applied in the direction of compressing the damping member.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A valve assembly for dispensing fluid intermittently, comprising:
a) a valve body having an axial bore;
b) a valve seat sub-assembly slidably disposed in said axial bore;
c) a valve needle sub-assembly disposed within said axial bore and selectively matable with said valve seat sub-assembly;
d) an actuator connected to said valve needle sub-assembly for moving said valve needle sub-assembly in alternating axial directions to cause said valve needle sub-assembly to make intermittent contact with and separate from said valve seat sub-assembly to control flow of said fluid from said outlet end; and
e) an energy attenuator sub-assembly fixedly disposed in said axial bore and in contact with said valve seat sub-assembly to bias said valve seat against said valve needle sub-assembly to dampen closing impact of said valve needle sub-assembly against said valve seat sub-assembly,
wherein said energy attenuator sub-assembly includes a compliant element.

2. A valve assembly in accordance with claim 1 wherein said valve assembly is a component of a fuel injector.

3. A valve assembly in accordance with claim 1 wherein said valve needle sub-assembly includes a valve end.

4. A valve assembly in accordance with claim 2 wherein said fluid is a hyrdocarbon fuel.

5. A valve assembly in accordance with claim 4 wherein said hydrocarbon fuel is compressed natural gas.

6. A valve assembly in accordance with claim 1 wherein said compliant element comprises a resilient polymer.

7. A valve assembly in accordance with claim 6 wherein said compliant element is formed of a fluorocarbon polymer.

8. A valve assembly in accordance with claim 6 wherein said energy attenuator sub-assembly further comprises a backing plate.

9. A valve assembly in accordance with claim 8 wherein said backing plate is an element formed integrally with said valve body.

10. A valve assembly in accordance with claim 8 wherein said backing plate is an element formed separate from and pressed into said valve body.

11. A valve assembly in accordance with claim 8 wherein said compliant element is bonded to said backing plate.

12. An internal combustion engine comprising at least one fuel injector including:
a valve body having an axial bore,
a valve seat sub-assembly slidably disposed in said axial bore,
a valve needle sub-assembly disposed within said axial bore and selectively matable with said valve seat sub-assembly,
an electrical actuator connected to said valve needle sub-assembly for moving said valve needle sub-assembly in alternating axial directions to cause said valve needle sub-assembly to make intermittent contact with and separate from said valve seat sub-assembly to control flow of said fluid from said outlet end, and
an energy attenuator sub-assembly fixedly disposed in said axial bore and in contact with said valve seat sub-assembly to bias said valve seat sub-assembly against said valve needle sub-assembly to dampen closing impact of said valve needle sub-assembly against said valve seat sub-assembly,
wherein said energy attenuator sub-assembly includes a compliant element.
